(19) United States
(12) Patent Application Publication
(10) Pub. No.: US 2019/0260757 A1
(43) Pub. Date: Aug. 22, 2019

(54) METHOD FOR DISABLING A DIGITAL ASSISTANT DURING A CONFERENCE CALL BASED ON SECURITY LEVEL

(71) Applicant: MOTOROLA SOLUTIONS, INC, CHICAGO, IL (US)

(72) Inventors: SUZANNE E. ERNESTI, GILBERT, AZ (US); MIKE F. ERNESTI, GILBERT, AZ (US); LEE M. PROCTOR, CARY, IL (US)

(21) Appl. No.: 15/902,326

(22) Filed: Feb. 22, 2018

(51) Int. Cl. H04L 29/06; G10L 15/22

(52) U.S. Cl. CPC H04L 63/105; G10L 2015/223; G10L 15/22; H04L 65/403

(57) ABSTRACT

A digital assistant and method are provided that allow for the digital assistant to be disabled during a conference call. An initial security level for a conference call is determined. A second conference device that is associated with the digital assistant is alerted of the initial security level. The second conference device sends the initial security level to the digital assistant. The functionality of the digital assistant is adjusted based at least in part upon the initial security level.

### BACKGROUND OF THE INVENTION

Digital assistants, such as the AMAZON ECHO and the GOOGLE HOME devices, are becoming more and more ubiquitous. These digital assistants can be very helpful in hearing questions and discussions and providing answers and relevant feedback. Digital assistant technology has also been integrated into cell phones, computers, televisions, and many other electronic devices.

In order to be responsive, many digital assistants are in active listening mode, which means that they are always listening to the sounds around them. Many have specific words that wake them up and get them ready to hear a request and respond appropriately. Although this is helpful in having the digital assistant always ready to respond, having digital assistants always listening can be disadvantageous. For example, an external source could link to a digital assistant and listen to private conversations that are within range of a digital assistant without the participants knowing that their conversation is being overheard. Such an eavesdropper could gain access to personal and confidential data and discussions, and use such information in a way that is adverse to the interests of the speakers.

An additional problem is that a person could unknowingly be in the vicinity of multiple devices that have the ability to listen. These devices may also have the ability to record what they hear, which could be very detrimental to the speaker and others whose voices could be heard by the digital assistants.

Further, many digital assistants process any received audio, such as speech, and pass the audio data to the cloud to be stored, for example, for training purposes. This can be problematic if the speech stored on the cloud includes sensitive information that was not intended to be heard by others or stored digitally.

Therefore, a need exists for a method of maintaining security restrictions while not losing the functionality of digital assistants.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 depicts a system diagram of a communication system in accordance with an exemplary embodiment of the present invention.

FIG. 2 depicts a flowchart in accordance with an exemplary embodiment of the present invention.

FIG. 3 depicts a flowchart in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

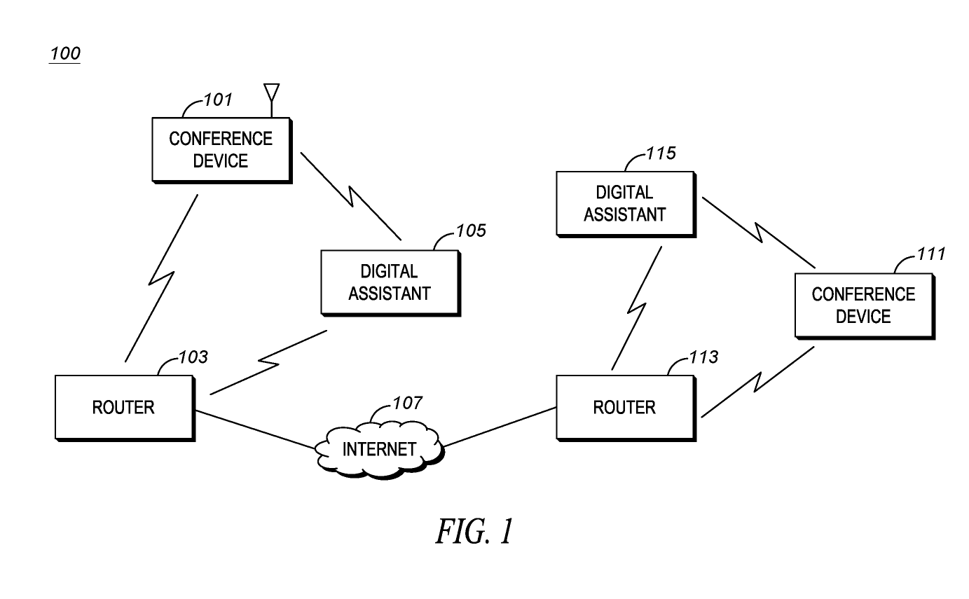

FIG. 1 depicts a system diagram of a communication system 100 in accordance with an exemplary embodiment of the present invention. Communication system 100 preferably comprises conference device 101, router 103, digital assistant 105, internet 107, conference device 111, router 113, and digital assistant 115. In an alternate exemplary embodiment, digital assistant 115 is connected directly to internet 107.

Conference devices 101 and 111 are telecommunications devices, and can be fixed or mobile devices. Conference devices 101 and 111 can be, for example, smart phones, desktop computers, laptop computers, tablets, monitors, or land mobile radios. Conference devices 101 and 111 are able to participate in conference calls or in talkgroup calls. Conference devices 101 and 111 connect to routers 103 and 113, respectively, via a wired or wireless connection, which may use a variety of communication protocols. Conference devices 101 and 111 also preferably connect wirelessly to digital assistants 105 and 115, respectively. It should be understood that this could also be a direct audio interface.

Routers 103 and 113 are networking devices that forward packets between computer networks. Routers 103 and 113 are connected to Internet 107 and perform the traffic directing functions to and from Internet 107. Routers 103 and 113 preferably receive IP packets from connected devices, such as conference devices 101 and 111 and digital assistants 105 and 115 and forward them to Internet 107. As an example, routers 103 and 113 can be cable routers or DSL routers that connect to Internet 107 via an Internet Service Provider (ISP). Routers 103 and 113 can utilize the same or different technologies.

Digital assistants 105 and 115 are devices that include a software agent that can perform tasks or services for an individual. Digital assistants 105 and 115 preferably work via receiving and responding to a voice command from a user. Digital assistants 105 and 115 preferably use natural language processing (NLP) to match user text or voice input to executable commands, and can utilize artificial intelligence methods to continually learn new functionality. Digital assistants 105 and 115 are preferably activated using a predetermined voice command or wake word. Digital assistants 105 and 115 can be cloud-based digital assistant, meaning that they are connected directly to internet 107.

Digital assistants 105 and 115 can be any of a wide array of digital devices. For example, digital assistants 105 and 115 can be smart speakers, smart phones with specific apps installed or within specific operating systems, within mobile apps from companies and organizations, smart watches, appliances, cars, mobile-enabled clothing, smart televisions, smart doorbells, and other smart devices.

Internet 107 is a global system of interconnected computer networks that use the Internet protocol suite (TCP/IP) to link devices worldwide. Internet 107 is a network of networks that comprises private, public, academic, business, and government networks of local to global scope, linked by a broad array of electronic, wireless, and optical networking technologies.

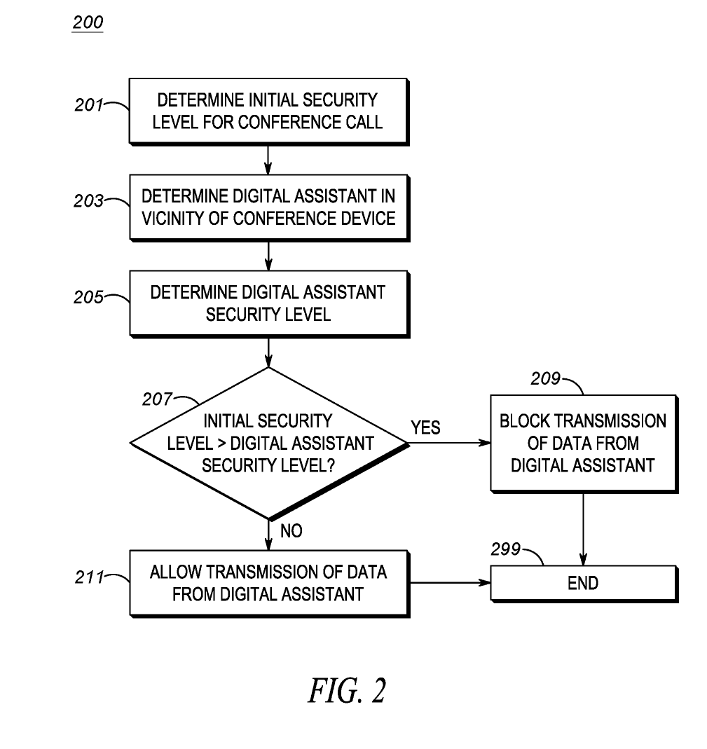

FIG. 2 depicts a flowchart 200 in accordance with an exemplary embodiment of the present invention.

In accordance with an exemplary embodiment, a conference call scheduler determines (201) an initial security level for a conference call. The user who creates the conference call can set the security level for the conference call. In a first exemplary embodiment, the creator of the conference call sets the security level to high, medium, or low, which can display on the conference call reservation as red, yellow, and green, respectively. For example, a bar can appear on the top of the conference call that indicates, using these colors, the security level for this conference call. The setting of the security level preferably occurs within the calendar program that is used to create the conference call. It should be understood that other security levels can also be used. It should be understood that the present functionality is also applicable to video calls utilizing any video call software or app.

As used herein, the term “conference call” can also refer to a talkgroup call in a land mobile radio system. In talkgroup calls, the dispatcher or talkgroup members can set the security level of the talkgroup. In this exemplary embodiment, the security level is preferably broadcast using short range communication, and proximate digital assistants not meeting the required security level disable.

Upon registering for the conference call, a conference device determines (203) that there is a digital assistant in its vicinity. In this exemplary embodiment, the determination of a digital assistant in the vicinity of the conference device is accomplished by detecting a data traffic stream from the digital assistant at router 103. In an alternate exemplary embodiment, the step of determining is accomplished by detecting known wakeup commands intended for digital assistants. In accordance with a further exemplary embodiment, the conference device preemptively sends a disable command to any proximate digital assistants based upon the security level of the call, even if no digital assistants are detected in the area.

The local conference device determines (205) the security level of the digital assistant. In accordance with an exemplary embodiment, the local conference device also determines the type of digital assistant, in order to determine how to disable the digital assistant. In addition, the local conference device also determines whether the digital assistant is a client-only digital assistant, a cloud-only digital assistant, or a hybrid. If the digital assistant is a cloud-assisted digital assistant, then the owner of the cloud, meaning the owner of the cloud service, may have the required security clearance or it may be a private server associated with the conference call. Security level detection could be via explicit wireless request/response, audio request/response, monitoring traffic at the router, or lookup-based on the determined model type.

The conference device determines (207) if the initial security level of the conference call is higher than the security level of the digital assistant. As used herein, “higher” or “greater” security means that a device has the ability to receive or have access to more information than a device with “lower” or “less” security.

If the conference device determines that the initial security level of the conference call is higher than the security level of the digital assistant steps are taken to either restrict the digital assistant from monitoring audio from conference call participants or to block transmission of audio signals to a cloud digital assistant. In one exemplary embodiment, router 103 blocks (209), at the request of either the conference device 101 or conference device 111, the transmission of data from digital assistant 105. In this exemplary embodiment, digital assistant 105 can be a cooperative digital assistant or a non-cooperative digital assistant. A cooperative digital assistant is a digital assistant that when receiving a command to modify settings or deactivate the digital assistant is trusted to follow the commands. A non-cooperative digital assistant is a digital assistant that cannot be trusted to follow commands sent to it or is unknown and therefore the system performs the commands remote from the digital assistant.

In an exemplary embodiment, router 103 blocks transmissions from digital assistant 105 at router 103, which can be at a firewall within router 103. The blocked transmissions can be voice or data. In accordance with an exemplary embodiment, once router 103 blocks transmissions from digital assistant 105, router 103 continues to block transmissions from digital assistant 105 during the extent of the associated conference call.

In accordance with an exemplary embodiment, router 103 blocks the transmission of data from digital assistant 105 by broadcasting a command to digital assistant 105.

If the conference device determines at step 207 that the initial security level of the conference call is not higher than the security level of the digital assistant, the process ends (299) and digital assistant 105 is allowed to transmit data.

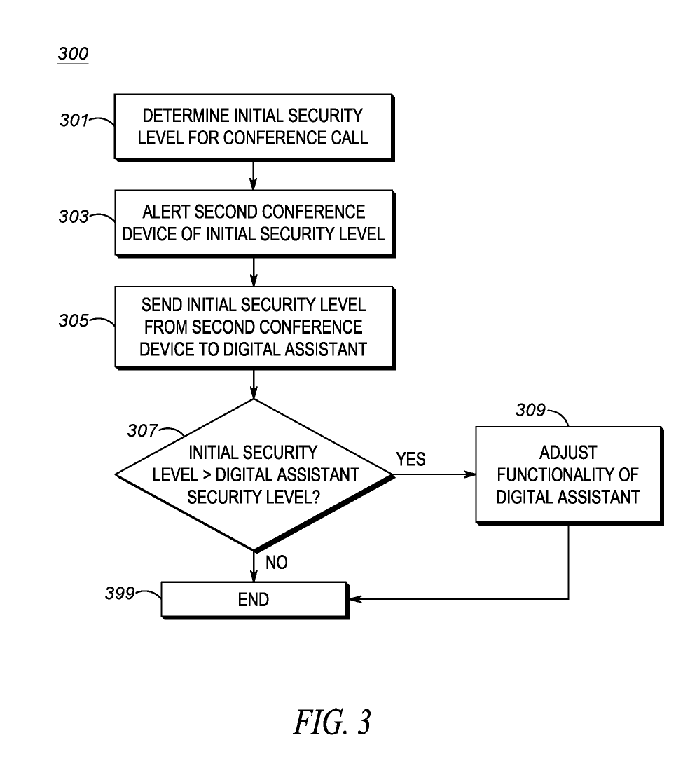

FIG. 3 depicts a flowchart 300 in accordance with an exemplary embodiment of the present invention. In this exemplary embodiment, digital assistant 105 is a cooperating digital assistant.

In accordance with an exemplary embodiment, a conference call scheduler determines (301) an initial security level for a conference call. The user who creates the conference call can set the security level for the conference call, and can be set as in FIG. 2 to high, medium, or low. In a further exemplary embodiment, the initial security level is tied to a talkgroup and is determined at the establishment of a talkgroup call.

In an exemplary embodiment, calendar software alerts (303) a second conference device of the initial security level. In an exemplary embodiment, the second conference device is alerted to the initial security level upon registering for the conference call. The security level is preferably displayed while the second conference device registers for the conference call. In a second exemplary embodiment, a participant in the conference call changes the initial security level during the conference call, and all digital assistants are adjusted appropriately. As used herein, a the second conference device is associated with the digital assistant when is it proximate to the digital assistant

The second conference device sends (305) the initial security level to a digital assistant. The initial security level is preferably set during the call setup by the call originator.

In an alternate exemplary embodiment, the security level of the call can be changed during the extent of the conference call. For example, a participant in the conference call can make a determination that the call has started to discuss sensitive matters and can update the security level of the ongoing call so that moving forward the call will be processed under the new security level.

In accordance with an exemplary embodiment, the digital assistant determines (307) if the initial security level is greater than the digital assistant security level. Alternately, this step could utilize the current security level if the security level is changed during the call.

If the initial security level is greater than the digital assistant security level, the digital assistant adjusts (309) the functionality of the digital assistant. In a preferred exemplary embodiment, the digital assistant disables its listening, or voice monitoring, function. The digital assistant would thereby not record any data received, since it would not be monitoring the voice data received.

In a further exemplary embodiment, the digital assistant adjusts its functionality by disabling the sending of received data to an external network, such as a server or the cloud. In one exemplary embodiment, the digital assistant monitors voice as in typical operation. However, when a voice command is received at the digital assistant, the digital assistant processes the command locally rather than sending to a remote server. For example, the digital assistant can utilize a local voice processor and access local computers or servers that are local, meaning within the scope of the router, to retrieve answers to voice commands. One example would be a request for the current weather, which could be answered by a local device and not a device on a network. In this manner, the digital assistant continues to provide functions and services that make it helpful without risking security by communicating with a server on an external network.

In a further exemplary embodiment, received voice commands can be parsed and processed prior to making a decision as to whether to send the received voice command to an external network or server. In one exemplary embodiment, speech to text algorithm converts a voice command to text, and a parsing algorithm reviews the text to determine if any or all of the text can be sent to an external network, such as the cloud, for processing. For example, a benign request, such as the current weather, can be passed to an external network for processing without being modified. In a further example, the digital processor will process the request locally when it determines the inclusion of predetermined words within the voice command. In a further exemplary embodiment, the digital assistant redacts predetermined words prior to sending the received command to an external network. This ensures that certain words or topics are not stored an external networks.

The digital assistant can also adjust its functionality in terms of when it wakes up. For example, certain digital assistant have a wakeup command to alert them that a voice command is about to be spoken. In one example, the word “ALEXA” is a wakeup word for the AMAZON ECHO. In this exemplary embodiment, the typical wakeup word is disabled to ensure that the device is not unintentionally woken up. In this exemplary embodiment, an alternate, preferably less common, wakeup command can be used to wake up the digital assistant. For example, the wakeup word for an AMAZON ECHO can be changed from “ALEXA” to “ALEXA, ALEXA, ALEXA” to wake up the digital assistant when the user is participating in certain conference calls or talkgroup calls, such as calls with a heightened security level.

If the initial security level is not greater than the digital assistant security level as determined at step 307, the process ends (399).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for blocking transmission from a digital assistant during a conference call, the digital assistant proximate to a conference device, the method comprising:
determining an initial security level for a conference call including the conference device;
determining a digital assistant security level associated with the digital assistant; and
if the initial security level is higher than the digital assistant security level, blocking transmission of data from the digital assistant.

2. The method of claim 1, the method further comprising the step of detecting the digital assistant by detecting a data traffic stream associated with the digital assistant at a router.

3. The method of claim 1, wherein the step of determining the initial security level for the conference call comprises obtaining the initial security level from a calendar entry associated with the conference call.

4. The method of claim 1, wherein the step of blocking transmission of data from the digital assistant comprises blocking transmission of speech detected at the digital assistant.

5. The method of claim 1, wherein the step of blocking transmission of data from the digital assistant comprises blocking transmission of data from the digital assistant during the extent of the conference call.

6. A method for disabling a digital assistant during a conference call, the method comprising:
determining an initial security level for a conference call including the conference device;
alerting a second conference device of the initial security level, the second conference device associated with a digital assistant;
sending the initial security level from the second conference device to the digital assistant; and
adjusting the functionality of the digital assistant based at least in part upon the initial security level.

7. The method of claim 6, wherein the initial security level is associated with a conference call reservation.

8. The method of claim 6, wherein the second conference device is associated with the digital assistant when it is proximate to the digital assistant

9. The method of claim 6, wherein the conference call is a talkgroup call.

10. The method of claim 6, wherein the step of determining an initial security level for a conference call comprises changing the initial security level based upon a request from a participant of the conference call.

11. The method of claim 6, wherein the step of adjusting the functionality of the second digital assistant comprises disabling voice monitoring at the digital assistant.

12. The method of claim 11, wherein the step of adjusting the functionality of the digital assistant comprises performing voice monitoring at a third device.

13. The method of claim 6, wherein the step of adjusting the functionality of the digital assistant comprises adjusting how the digital assistant wakes up.

14. The method of claim 6, wherein the step of adjusting the functionality of the digital assistant comprises disabling recording by the digital assistant.

15. The method of claim 6, wherein the step of adjusting the functionality of the digital assistant comprises preventing the digital assistant from sending information to an external network.

16. The method of claim 6, wherein the step of adjusting the functionality of the digital assistant comprises processing queries by the digital assistant at a local processor.

17. The method of claim 6, wherein the step of adjusting the functionality of the digital assistant comprises utilizing a local voice processor to process received audio commands.

18. A digital assistant comprising:
a receiver configured to receive an initial security level for a conference call; and
a processor configured to adjust the functionality of the digital assistant based at least in part upon the initial security level.

19. The digital assistant of claim 18, wherein the processor is further configured to disable voice monitoring at the digital assistant.

20. The digital assistant of claim 18, wherein the processor is further configured to prevent the digital assistant from sending information to an external network.
